(19) United States
(12) Patent Application Publication
(10) Pub. No.: US 2003/0098523 A1
(43) Pub. Date: May 29, 2003

(54) Method to mold signs or other 3D plaques by utilizing fiber reinforced thermoset plastic for both the mold and the finished product to produce a homogeneous sign system

(76) Inventor: Daniel Ernest Oppenheimer, Memphis, TN (US)

Correspondence Address: DANIEL E OPPENHEIMER, 4055 ST ANN CL, MEMPHIS, TN, 38117, US

(21) Appl. No.: 09/793,819

(22) Filed: Feb. 23, 2001

(51) Int. Cl. B29C 33/40; B29C 43/02

(52) U.S. Cl. 264/219; 264/320

(57) ABSTRACT

This invention relates to a method of manufacture of short run production of 3 dimensional decorative or functional plaques or products out of thermoset plastic material especially as it relates to the manufacture of 3 dimensional raised letter/Braille signs through the utilization of compression molded thermoset plastic molds that are themselves molded around masters that are created by machining, sandblast carving or other conventional fabrication techniques.

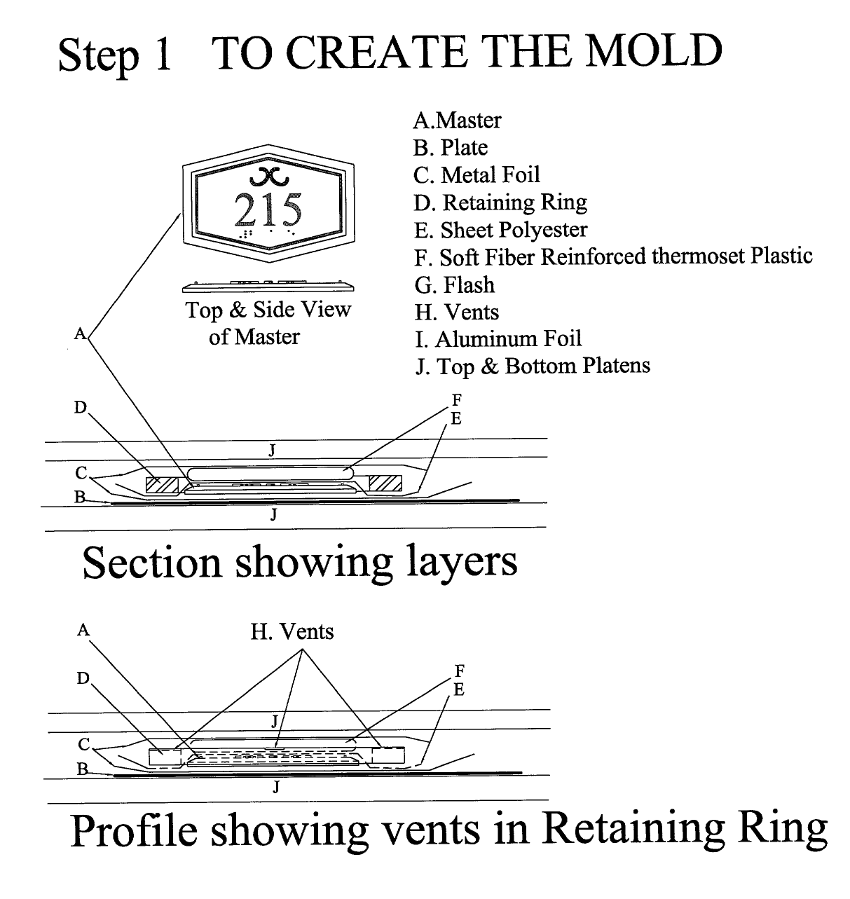

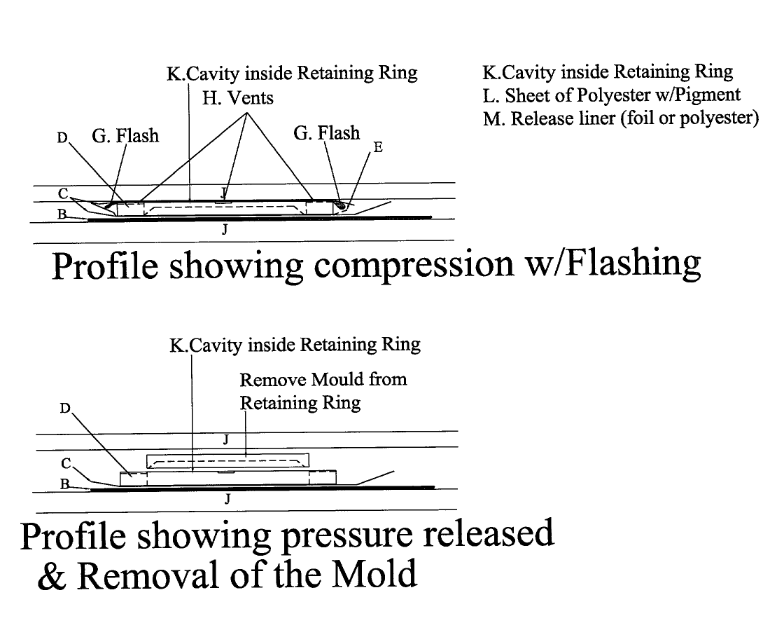

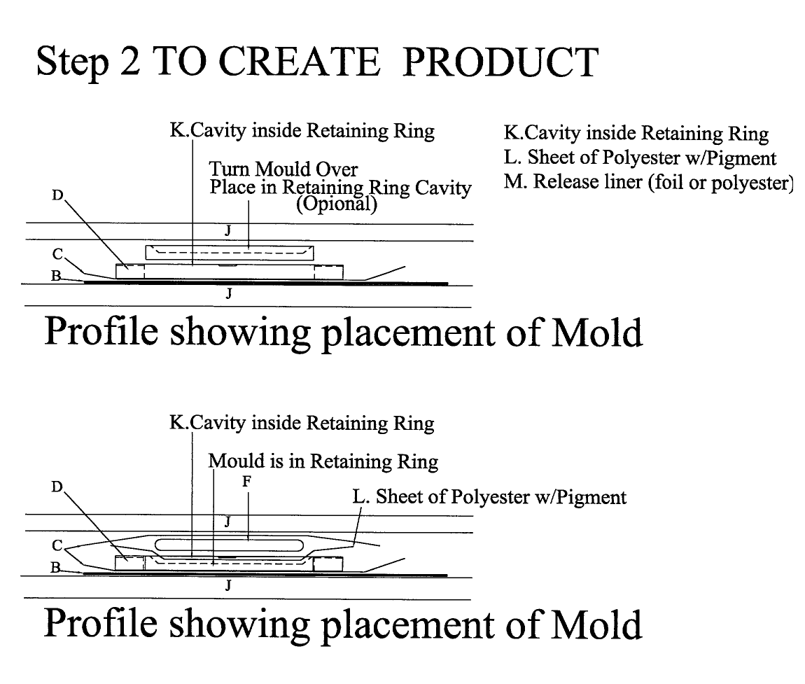

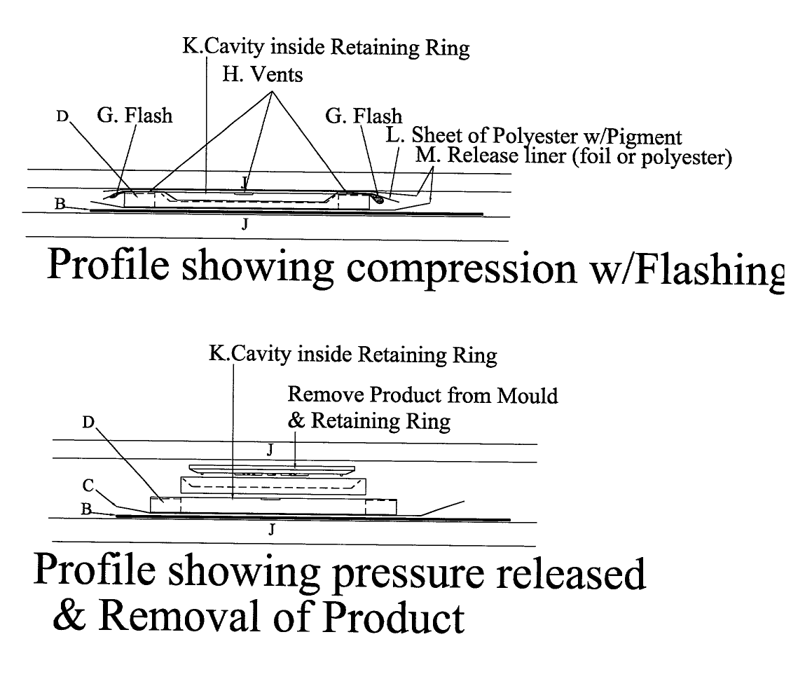

This invention also relates to a method of manufacturing a system of signs for commercial buildings including but not limited to hotels, hospitals, health care, offices, residential developments and any other real estate development requiring the use of ADA compliant raised letter/Braille signage or 3 dimensional decorative signage or decorative elements. The means by which this is accomplished is through the use of thermoseting plastic as both a mold material and as the finished product.

### SUMMARY

This invention relates to a method of manufacture of short run production of 3 dimensional decorative or functional plaques or products out of thermoset plastic material especially as it relates to the manufacture of 3 dimensional raised letter/Braille signs through the utilization of compression molded thermoset plastic molds that are themselves molded around masters that are created by machining, sandblast carving or other conventional fabrication techniques. This invention also relates to a method of manufacturing a system of signs for commercial buildings including but not limited to hotels, hospitals, health care, offices, residential developments and any other real estate development requiring the use of ADA compliant raised letter/Braille signage or 3 dimensional decorative signage or decorative elements.

The method of manufacture utilizing compression molds themselves manufactured by compression molding of thermoset reinforced resin plastic is the basis for this part of the invention. Typically in short run or prototype compression molding operations molds are made of aluminum, Kirksite, silicon bronze or low carbon steel. A Dough or Bulk Molding Compound, D.M.C. or B.M.C. is preformed to an approximate shape and weight calculated to completely fill the cavity of the heated mold thus insuring that the full pressure is exerted upon all of the material in the mold. Because the pressure can be quite high (up to 2000 lbs per square inch of surface area) historically only metals have been utilized for this kind of molding process. The nature of the items we are producing allows for the utilization of molds made of reinforced thermoset plastics. Because our products have a great width and length to depth or height ratio we are able to utilize this very unconventional molding process. Complex surface texture or bas-relief is possible with this process due to the typical ratio of depth to width and height. Were our parts deeply drawn such as one might find in the products conventionally molded from B.M.C. conventional mold materials would be required

The following is a complete description of the process I utilize in producing both the mold and the finished product.

1a. First a master is made through any of several techniques. As it relates to raised letter/Braille signage the master is produced by engraving an original. This can be accomplished by either reverse engraving, positive engraving or a combination of both. These techniques are well known to those skilled in the sign trade.

1b. A master is made by photographically developing a 3 dimensional image (sign) out of a photopolymer material and/or mounting the photopolymer to a substrate to add additional depth and dimension. This technique is also well known to the sign trade.

1c. A sign might be hand carved, though this is a rarely done procedure and when done it is usually combined with other techniques mentioned in this section.

1d. A sign or decorative or functional plaque may be fabricated by adhering individual components to the surface of a substrate of any number of materials. For example an acrylic plate might have plastic domes glued to the surface or holes drilled in the surface for the insertion of plastic balls. Ref. U.S. Pat. No. 5,245,744. This method of sign fabrication is well known to those skilled in the trade.

1e. Although less commonly practiced, signs or decorative or functional plaques can be selectively sandblasted by selectively covering or masking any material that by its physical nature can be abrasive etched. Common material that can be decorated by sandblasting includes glass, stone, ceramic and certain plastic material including phenolic and polyester resins. A number of sign companies sandblast Dupont's Corian or other like material in order to produce a raised letter/Braille sign with the background or etched away surface retaining a similar appearance as the original surface. Ref. U.S. Pat. No. 4,985,101 (abandoned)

This invention also relates to a variation on the above mentioned patent (U.S. Pat. No. 4,985,101) whereby instead of relying on the glass or other fiber found in the glass resin sheet for texture as discussed in this patent but instead relies upon the lack of texture produced by sandblasting the surface through the addition of a thin layer of fiber free resin to a fiber impregnated sheet. The sandblast process attacks only the non fiber-layer resulting in the smooth texture. The production of this material is accomplished by laminating a thermoset plastic (typically polyester resin) under heat and pressure as described in the rest of this invention. This allows a master to be made by sandblasting that simulates a photopolymer sign or a smooth textured Corian sign.

1f. Another method of sign or plaque production is the casting process whereby molten metal is poured into a sand cast mold that has been created by using a photopolymer plate to make an impression in the sand or by utilizing conventional type-setting to produce a “match plate” for sand impression.

1g. Another method for sign or decorative plaque production includes acid etching of metals through utilization of photographic or computer cut masking techniques.

1h. Signs or decorative plaques can be made by casting catalytic resin or other highly viscous casting materials into rubber or silicone molds.

1i. Signs can be injection molded through conventional means though this process is generally reserved for high production ‘common signs’ or decorative plaques such as “mens”, “womens”, or office signs in which the manufacturer knows he will produce enough product to justify the relatively high cost of the tooling.

In this manufacturing process a master is first produced by any of the above mentioned means though from a practical point of view signs made by means of 1a, 1b, 1c, 1d, 1e, 1f, 1g are more feasible.

Once the master (A. see drawings) is made, it is placed face up on a flat metal (or other heat conductive non-compressive) plate (B.) that is covered with metal foil (C.) or other release liner material. A steel outer retaining ring (D.) that is designed to allow for an approximately ½″ inside clearance around the master such that both the master and the retaining ring now reside on the foil (or release liner) on top of the plate. The plate can be eliminated when there is enough daylight (opening in the press to work). With the ring in place and the master centered in the ring (a small amount of adhesive maybe used to hold the master or ring in place). A sheet of polyester (E.) or other similar strong thin high temperature film is placed over the entire assembly with enough overage to protect the surrounding areas from the thermoset material. A “preform” of fiber reinforced thermoset plastic (F.) material (typically polyester resin) impregnated with glass fiber or sisal fiber (chopped or mat) with common fillers (calcium carbonate and other materials) is weighed and placed within the retaining ring. The weight is important because it will ensure that there is enough material to fill the entire cavity with a small amount of overage. This excess is forced out of the ring either as natural flash (G.) or through small vents (H.) ground into the top edge of the ring. Typically these vents are 0.003 in deep×0.5 in wide and are about every 6″ or so. Once the preform is in place a sheet of aluminum foil (I.) or polyester is placed over the top of the entire formation. The formation is then placed in a laminating press where the 2 platens (J.) have been preheated to approximately 325° F. The press is activated and the platens close on the formation forcing the preform of B.M.C. or D.M.C. into every crack and crevice of the cavity (K.) The pressure is brought up to approximately 2000 lbs per square inch of surface area and the press is allowed to sit for approximately 5 minutes. After the 5 minutes the pressure is released and the platens are separated. The mold is now removed from the retaining ring and the master separated from the mold with compressed air or a simple yank on the polyester film releases the master from the mold. Vents are then cut into the top edge of the B.M.C. mold with a file or other cutting tool and the mold is now immediately ready to use to produce parts.

To produce parts the mold is placed face up on the carry plate (B.), several molds at a time to maximize efficiency. The molds are covered with a thin polyester film (pigmented optional) (L.) that has been coated with either a matte clear or colored pigment or a printed design pigment. The pigment side is placed face up such that when the part is formed the pigment is transferred from the polyester film to the B.M.C. during the compression and curing cycle. This is done for 2 reasons. First this is an extremely durable coloration method of the finished part in that the pigment is literally fused into the first few thousandths of an inch of the surface. Further it is a natural phenomenon that as the pigment fuses into the surface of the part a natural mottling takes place that enhances the surface appearance of the part. Secondly, if a matte or glass clear pigment is used then the high points of the part can be readily “hot stamped” with the same “foil”. By using a pigmented B.M.C. the base material becomes the appearance surface and the contrasting high spots can be readily hot stamped. Hot stamp pigments will adhere readily to the transferred coating and other materials but will not adhere readily to raw polyester B.M.C. Once the polyester has been placed over the molds, preforms of the B.M.C. are placed in the cavities of the molds. Again the preforms are weighed, formed and placed in such a way as to insure adequate filling of the molds. A release liner (foil or polyester) fill is then placed over all of the molds and preforms (C.). Pressure is then applied along with the heat. The same pressure and heat will be fine though much less time is needed. For a 3/16-¼ inch thick plaque approximately 2 minutes are required in the press. At the 2 minutes signal the press is opened and the parts are released from the molds. The casting is removed and the edges cleaned with a file or other abrasive flat surface. If touch up is required on the edge this is the time to do it. A beveled edge plaque or any other shape that tapers to a fine edge helps significantly to release the part from the mold. The signs are then hot stamped or silk screened or surface sanded on the high spots to allow a contrasting color.

Prior Art: The entire process previously described is based upon the utilization of fiber reinforced thermoset plastic commonly known as Bulk or Sheet Molding Compound as the material the master mold or die is made of. Evidence of prior use of this methodology is unknown to the inventor; in fact, the contrary seems to be the case. Interviews with those skilled in the trade for many years has produced no individual claiming to have ever heard of such an application. This inventor refers to the 2^{nd} Edition of Handbook of Composites edited by S. T. Peters, process Research, Mountain View, Calif. USA published by Chapman & Hall 1998 ISBN 0 412 54020 7. This handbook is widely considered one of the pre-eminent if not the most important compilation of composite technology in the field today. As it relates to this invention nowhere in the entire handbook is there any mention of the utilization of B.M.C. or S.M.C. as a practical mold material for compression molding of these thermoset plastics. In fact the recommended mold material for BMC compression molding is chrome-plated steel of varying degrees of hardness depending on the life expectancy of the molds. Ref. Pg.392, 394. Additional information about mold material for compression molding is published in Glass Reinforced Plastics edited by Philip Morgan 1961, published by liffe Books Ltd. London, UK published in the USA by Interscience Publishers Inc. NY, N.Y. On page 147 of this handbook specific language exists that states that the use of “plastics and other non metallic molds are of limited value in Bulk Molding Compound prototype work:” This is in reference to prototype work or short runs as opposed to production runs. The author uses terms and phrases such as “lack of tensile strength”, “troublesome, and dimensional accuracy and finish are likely to be poor.” “The number of lifts will be limited and molds for complex shapes will be very difficult to make.” Further the author goes on to say “For prototype work and short-run molds, metals such as aluminum, Kirksite, silicon-bronze or low carbon steel are used.” No other information has been discovered by this inventor concerning the use of fiber reinforced plastic in compression molding.

This invention relates to a process for manufacturing a sign system of 3 dimensional graphics, specifically raised letters and Braille as required by the 1992 Americans With Disabilities Act. In virtually all commercial buildings there can be found a family of signs identifying rooms or spaces or providing information such as instructions or directions. Certain signs are required to have raised letters and grade II Braille (ADA 1992). In the case of hotels there are a great number of signs identifying permanent rooms (guest room numbers, conference rooms, office, ice vending, stairs, etc.) that are common to all hotels of a particular design. For example the brand Hampton Inn has a very specific sign standard that call out the exact size shape and 3 dimensional quality of the signs required by the parent company of the hotels. These standards conform to both the ADA standards and the corporate standards for design. It is safe to assume that a great number of the signs found in a Hampton Inn (and many other brands) will be the same design though colors will vary. You will almost always find a room 101, room 102, room 103, men, women, Ice & Vending etc. But not all Hampton Inns are exactly alike. Though most are 3 floors, some are 4 floors, there are even 10 story Hampton Inns. The signs that direct you to your room vary dramatically. In one hotel room 101 might be to the right and in the next room 101 might be to the left. Because there are generally less than 1000 hotels in any chain and due to the fact that in any year less than 100 are built or renovated, the need for a low cost low volume production method of sign fabrication is advantageous. Up to this point virtually all signs that are brand specific for hotels, hospitals and other buildings that require professionally designed signage have been made one at a time by the methods described above with exception of injection molded signs. It is this reason this process was invented. There are simply too many disadvantages in mass production methods of producing a system of signage that conforms to the design standards set by the design community for particular properties. Previously the only 2 methods for low cost cast or molded signs have been resin cast signs formed of catalytic polymer resin cast in polyurethane or silicone molds, or injection molded signs, conventionally molded of thermoforming plastic. There are disadvantages of each. The resin signs require a less expensive mold than a tooled steel or aluminum injection mold but are still costly when one considers the low quantities required relative to the mold cost and the skill level to produce good product. A silicone or urethane mold takes a great deal of skill to produce if it is to result in an accurate casting. Typically the parallelness of a finished resin sign should be ±0.005 in order to allow hot stamping of the raised surface. Also, in larger signs or plaques or in thin plaques there is a natural tendency of these signs to warp. They are also quite brittle and will break readily. They can be made to work if their design calls for a thick sign or frame. A problem is that most design standards for buildings do not lend themselves well to this method of fabrication for the reasons stated above.

In the case of plastic injection molding the finished product is quite acceptable, but the cost of the tooling does not justify the price that must be charged to be competitive in the market place. With a typical die cost of 2-5 thousand dollars each and the risk of a design becoming out-dated due to design change, it is simply not cost efficient to injection mold brand specific signage. If one is going to make only generic signs with no brand logo or special designs then injection molding is indeed practical. The problem arises as soon as a designer wants a custom look or a brand specific look. Injection molded signage also has a “cheap” look to it and is rejected for most up scale properties. Embassy Suites brand will no longer allow a plastic looking sign in their properties.

In summation, injection molded signs do not have a place in the low-end market but are of limited value to design conscious building owners, architects, and designers.

For these reasons I have developed this invention. With it I can make an original or master conventionally then in only 5 to 10 minutes make 1 mold at a material cost of less than $1.50 and almost immediately make castings every 2 to 3 minutes for less than 25¢ each (material cost). Because of low mold cost and the speed of production I can make the majority of the signs for a complete sign system in a fraction of the time required using conventional means. In time and material analysis, this process is so cost and time effective that one only has to make 2 signs, the original and the first copy and realize a lower cost than by making 2 signs by any of the conventional means described in 1a-1. Further, because this process utilizes a conventionally produced original sign to make the mold for subsequent compression casting, then other signs required for a unique specification such as directional signage (as previously described) can be made in the conventional manner and will still match that of a compression molded sign produced by this process.

This feature is the key to the economic reality of this invention. The fact that we can produce cost efficient compression molded duplicates the very first time we compression mold coupled with the fact that any one-of-a-kind additional signs will match the duplicates in look exactly allows a homogeneous sign system that will meet or exceed the demanding standards found in the construction industry today.

To recap, the fundamentals of this invention are as follows:

1. This invention describes a means by which to produce a very low cost compression mold by forcing fiber reinforced plastic in the form of polyester resin bulk molding compound around all but one surface of a flat decorative plaque consisting of a minimum relief particularly as it relates to raised letter Braille signage.

2. The mold cavity that results from step 1 enables the reproduction of the original master plaque in the same basic manner used to produce the mold.

3. This method of mold and plaque production coupled with conventional means to manufacture the original used to make the mold in the first place allows the production of a homogeneous sign system that utilizes both the very low cost casting from the mold duplicates and the original conventional one of a kind non standard signs that are made one at a time. The net effect is to dramatically reduce the time and cost required to produce a wide range of very high quality signage systems

1. What I claim my invention is a system of producing economical molds of thermosetting plastic fiber reinforced material and the resulting signs or 3D plaques from the molds made of the same basic material as the molds.
